(19) United States
(12) Patent Application Publication
(10) Pub. No.: US 2008/0233449 A1
(43) Pub. Date: Sep. 25, 2008

(54) MIXING TANK AND FUEL CELL SYSTEM POSSESSING THE SAME

(76) Inventors: Dae-ho Ko, Suwon (KR); Jung-kurn Park, Suwon (KR); Won-hyouk Jang, Suwon (KR); Ulrike Krewer, Suwon (KR); Dong-myung Suh, Suwon (KR); Tong-jin Park, Suwon (KR); Eun-suk Cho, Suwon (KR); Sang-jun Kong, Suwon (KR); Do-young Kim, Suwon (KR)

Correspondence Address: CHRISTIE, PARKER & HALE, LLP, PO BOX 7068, PASADENA, CA, 91109-7068, US

(21) Appl. No.: 12/038,771

(22) Filed: Feb. 27, 2008

(30) Foreign Application Priority Data
Mar. 19, 2007 (KR) 10-2007-0026656

(51) Int. Cl. H01M 8/04; F16L 53/00

(52) U.S. Cl. 429/26; 137/334

(57) ABSTRACT

A fuel cell system possessing a mixing tank for recovering an unreacted fuel, the mixing tank being capable of effectively condensing a stack emission product without increasing its volume. The mixing tank includes a fuel supply port for supplying a concentrated fuel; a fluid inlet port for supplying a fluid discharged from an external fuel cell stack; a chamber for mixing the concentrated fuel with the fluid discharged from the fuel cell stack; a stack supply port for supplying a mixed fuel in the chamber to the fuel cell stack; and a chamber cooling member for cooling the chamber.

### CROSS-REFERENCE TO RELATED APPLICATION

This application claims priority to and the benefit of Korean Patent Application No. 10-2007-0026656, filed on Mar. 19, 2007, in the Korean Intellectual Property Office, the entire content of which is incorporated herein by reference.

### BACKGROUND

1. Field of the Invention

The present invention relates to a fuel cell system possessing a mixing tank for recovering an unreacted fuel.

2. Discussion of Related Art

A fuel cell is a generator system for directly converting a chemical energy into an electric energy using an electrochemical reaction of oxygen with hydrogen. The hydrogen can be pure hydrogen that is directly supplied to a fuel cell system, or can be hydrogen obtained by reforming raw materials such as methanol, ethanol, natural gas, etc. that is supplied to a fuel cell system. The oxygen can be pure oxygen that is directly supplied to a fuel cell system, or can be oxygen included in ambient air that is supplied to a fuel cell system using an air pump, etc.

Examples of fuel cells include polymer electrolyte and direct methanol fuel cells that operate at a room temperature or a temperature not greater than 100° C., phosphate fuel cells that operate at a temperature ranging from about 150 to 200° C., molten carbonate fuel cells that operate at a high temperature ranging from 600 to 700° C., and solid oxide fuel cells that operate at a high temperature of 1,000° C. or above. These fuel cells are substantially identical in their operation principles for generating electricity, but different from each other in the kinds of fuels, catalysts, electrolytes, etc. they used.

Among the above fuel cells, the direct methanol fuel cell (DMFC) uses liquid high density methanol mixed with water as its direct fuel instead of hydrogen. The direct methanol fuel cell has a lower power density than a fuel cell using hydrogen as the direct fuel; however, it has a higher energy density per unit volume of methanol used as the fuel and can be easily stored. As such, the direct methanol fuel cell can be used in a system requiring a low power output but a long operation time. In addition, the direct methanol fuel cell can easily be downsized because it doe not require a reformer for reforming a fuel to generate hydrogen.

Also, the direct methanol fuel cell includes an electrode-electrolyte assembly (Membrane Electrode Assembly: MEA) composed of an anode electrode, a cathode electrode, and an electrolyte membrane between (and/or in contact with) the anode electrode and the cathode electrode. In one embodiment, a fluoro-polymer and the like can be used as the electrolyte membrane. However, since methanol having a high density rapidly permeates in the fluoro-polymer, unreacted methanol penetrates the electrolyte membrane if the methanol is used as the fuel. This is called a crossover phenomenon. Accordingly, to lower a density of methanol, a mixed fuel of methanol and water can be supplied to a fuel cell system.

### SUMMARY OF THE INVENTION

Aspects of embodiments of the present invention are directed toward a mixing tank capable of effectively condensing a stack emission product without increasing its volume, and a fuel cell system possessing the same.

Aspects of embodiments of the present invention are directed toward a fuel cell system and a mixing tank capable of effectively recovering an unreacted fuel without increasing a volume of the entire system.

An embodiment of the present invention provides a mixing tank including: a fuel supply port for supplying a concentrated fuel; a fluid inlet port for supplying a fluid discharged from an external fuel cell stack; a chamber for mixing the concentrated fuel with the fluid discharged from the fuel cell stack; a stack supply port for supplying a mixed fuel in the chamber to the fuel cell stack; and a chamber cooling member for cooling the chamber.

In one embodiment, the chamber cooling member has a structure for cooling an upper gas collection region of the chamber.

Another embodiment of the present invention provides a fuel cell system including a fuel cell stack for generating electricity by a chemical reaction of oxygen with hydrogen; a fuel tank for storing a high-density hydrogen-containing fuel; a mixing tank for mixing a reacted emission product of the fuel cell stack with the high-density hydrogen-containing fuel stored in the fuel tank and comprising a chamber; and a chamber cooling member for cooling the chamber of the mixing tank.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block view schematically showing a conventional direct methanol fuel cell system.

FIGS. 2A, 2B, and 2C are cross-sectional views schematically showing embodiments of mixing tanks according to the present invention.

FIG. 3 is a block view schematically showing an embodiment of a direct methanol fuel cell system possessing the mixing tank as shown in FIG. 2A.

FIG. 4 is a block view schematically showing another embodiment of a direct methanol fuel cell system possessing the mixing tank as shown in FIG. 2B.

FIG. 5 is a block view schematically showing another embodiment of a direct methanol fuel cell system possessing the mixing tank as shown in FIG. 2B.

FIG. 6 is a block view schematically showing another embodiment of a direct methanol fuel cell system possessing a mixing tank according to another embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

In the context of the present invention, a fuel cell stack can refer to a stack composed of laminated unit cells; a stack composed of flat unit cells; or a unit stack including a single unit cell.

Also, a direct methanol fuel cell system is described in detail, but a fuel cell system possessing a mixing tank for re-using an unreacted fuel (for example, a fuel cell system using an aqueous acetate solution as a fuel) may be used herein without departing from the scope and spirit of the present invention.

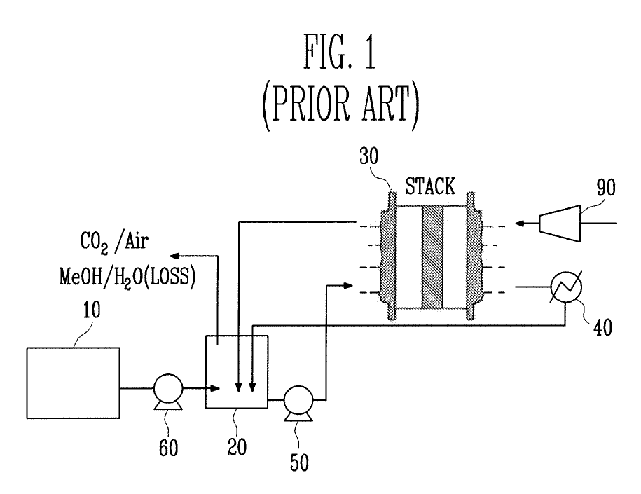

FIG. 1 is a diagram schematically showing a configuration of a conventional direct methanol fuel cell.

As shown in FIG. 1, the direct methanol fuel cell includes a fuel cell stack 30 for generating electricity through a chemical reaction of oxygen with hydrogen gas; a fuel tank 10 for storing a high density fuel (or a high-density hydrogen-containing fuel or a concentrated fuel) to be supplied to the fuel cell stack 30; a condenser 40 for recovering the unreacted fuel discharged from the fuel cell stack 30; and a mixing tank 20 for supplying a hydrogen-containing fuel, which is obtained by mixing the unreacted fuel discharged from the condenser 40 with the high density fuel discharged from the fuel tank, to the fuel cell stack 30.

Here, in FIG. 1, a plurality of unit cells are provided in the stack 30, the unit cells including a membrane electrode assembly (MEA) composed of a cathode electrode, an anode electrode, and a polymer membrane between (and/or in contact with) the polymer membrane. The anode electrode oxidizes methanol in the mixed fuel supplied from the mixing tank 20 to generate hydrogen ions (H+) and electrons (e−). The cathode electrode converts oxygen in the air that is externally supplied (e.g., from an air pump 90) into oxygen ions and electrons. The polymer membrane is a conductive polymer electrolyte membrane having a function of preventing the penetration of a hydrogen-containing fuel, as well as a function of ion-exchanging the hydrogen ion generated in the anode electrode into the cathode electrode.

An electric energy generated by the chemical reaction of oxygen with hydrogen gas in the unit cell is converted into a suitable electric current/voltage, etc. for an output level using a power conversion device, and the converted electric current/voltage is outputted in the form of external loads. The power conversion device may also have a structure for charging a separate secondary battery.

Also, the direct methanol fuel cell further includes a fuel pump 60 for pumping a high density fuel in the fuel tank 10 to a mixing tank 20; and a feed pump 50 for pumping a mixed fuel in the mixing tank 20 to the anode electrode, and it may further include a drive controller for controlling the operations of the fuel pump 60, the feed pump 50 and a condenser 40, depending on the generation of electric power in the fuel cell system. The drive controller serves to sustain a constant density of the mixed methanol fuel supplied from the mixing tank 20 to the anode electrode of the fuel cell stack 30, thereby to stably sustain a power generation efficiency of the fuel cell system.

An unreacted fuel, which is discharged from the cathode electrode when carbon dioxide (CO₂) is mixed with water (H₂O), moves into the condenser 40, and the unreacted fuel condensed in the condenser 40 is collected in the mixing tank 20. Gaseous components such as carbon dioxide in the unreacted fuel are separated in the mixing tank 20 and emitted out of the mixing tank 20. The high density fuel supplied from the fuel tank 10 and the unreacted fuel collected in the mixing tank 20 are mixed with each other, and then supplied to the anode electrode of the fuel cell stack 30.

In case of the conventional fuel cell system as shown in FIG. 1, the gaseous cathode emission product is first condensed into a liquid state through the condenser 40, and then flows into the mixing tank 20. However, a significant amount of an emission product emitted from the cathode electrode remains as gas since the emission product is not significantly condensed through the condenser 40 due to its relatively high temperature. Gaseous components are removed from the cathode emission product by a gas/liquid separator installed in the mixing tank 20 or by natural gas/liquid separation in the mixing tank 20, the cathode emission product being obtained by mixing the gas and the liquid flowing in the mixing tank 20, and therefore only liquid components remain in the mixing tank 20.

As described above, although the conventional fuel cell system has the condenser 40 and the mixing tank 20, it does not prevent the loss of a significant amount of uncondensed methanol gas along with CO₂.

Moreover, if the condensation performance of the condenser 40 is improved to prevent (or significantly reduce) the loss of methanol in the form of gas, the loss of methanol may be reduced, but the manufacturing cost of the condenser 40 is high.

Also, the condenser 40 and the mixing tank 20 of the conventional fuel cell system have relatively large volumes, which can be an obstacle to manufacture a small fuel cell system.

### Embodiments

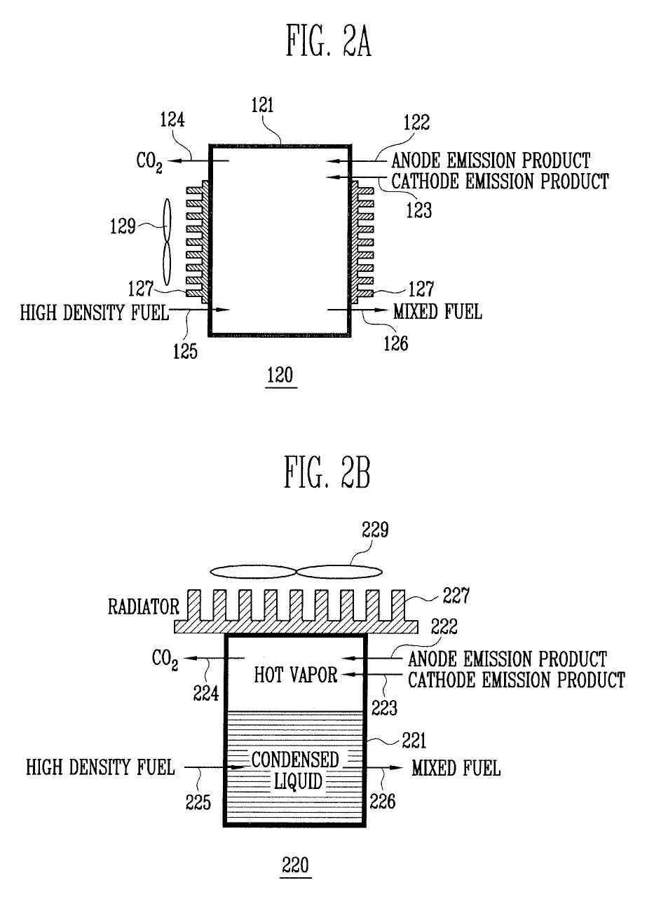

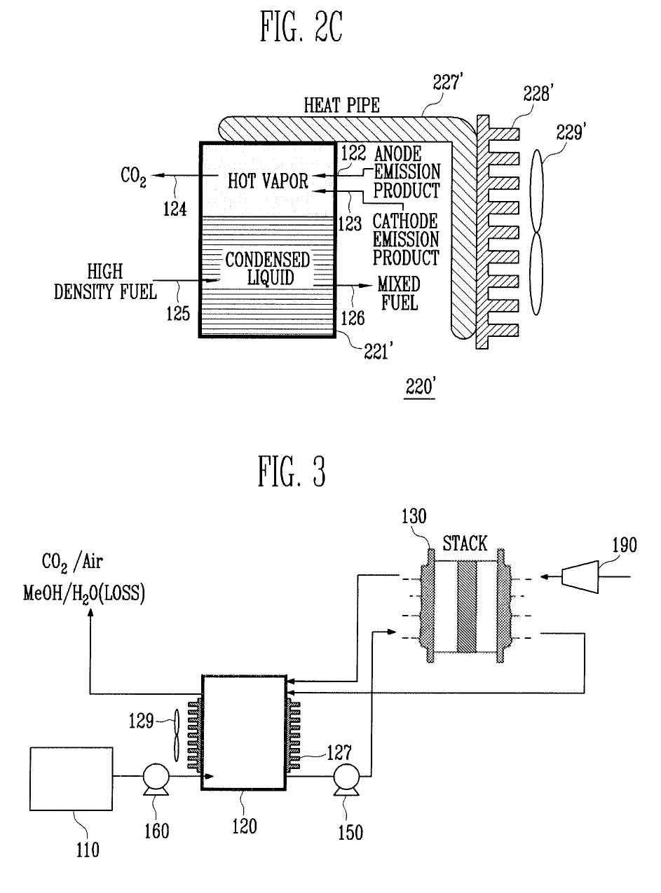

As shown in FIG. 2A, a mixing tank 120 according to an embodiment of the present invention includes a fuel supply port 125 for supplying a high density fuel (or a high-density hydrogen-containing fuel or a concentrated fuel); a cathode inlet port 123 for supplying a cathode emission product from an external fuel cell stack; an anode inlet port 122 for supplying an anode emission product from the fuel cell stack; a chamber 121 for mixing the high density fuel, the cathode emission product and the anode emission product; a stack supply port 126 for supplying a mixed fuel in the chamber 121 to the fuel cell stack; and a cooling member for cooling the chamber 121.

The cooling member is composed of a radiator 127 attached to an outer wall of the chamber 121; and a ventilation member 129 for blowing air into the radiator 127. The radiator 127 is formed with a plurality of heat-radiating pins (or heat-radiating wrinkles or heat-radiating fins) to enhance a cooling efficiency for a mixed liquid (the mixed fuel) stored in the mixing tank 120.

The ventilation member 129 may be realized with an air pump or a blower fan. However, the ventilation member 129 can also be used in other application, for example, can be used for supplying an oxidant to a cathode (a cathode electrode) of a fuel cell stack, since the ventilation member 129 may supply the air, blown from one air pump, to several parts through a duct, etc.

As shown in FIG. 2B, a mixing tank 220 according to one embodiment of the present invention includes a fuel supply port 225 for supplying a high density fuel; a cathode inlet port 223 for supplying a cathode emission product from an external fuel cell stack; an anode inlet port 222 for supplying an anode emission product from the fuel cell stack; a chamber 221 for mixing the high density fuel, the cathode emission product and the anode emission product; and a stack supply port 226 for supplying a mixed fuel in the chamber 221 to the fuel cell stack.

Here, a radiator 227 formed on an upper outer surface of the chamber 221; and a ventilation member 229 for blowing air into the radiator 227 are installed as a cooling member in an upper gas collection region of the chamber 221, and therefore the upper gas collection region of the chamber 221 may intensively cooled.

The cathode emission product obtained by mixing gas and liquid flowing from the cathode inlet port 223; an aqueous unreacted methanol solution flowing from the anode inlet port 222; and the high density fuel flowing from the fuel supply port 225 are mixed in the chamber 221. Here, gaseous components having a low density are collected in an upper region of the chamber 221 due to the action of gravity.

In the case of the conventional mixing tank, the gas collected in the upper region of the chamber 221 is discharged out of the chamber 221 to the outside through an exhaust pipe, and the mixing tank 220 as shown in FIG. 2B is cooled by a separate cooling member. For this purpose, a gas exhaust pipe for discharging the gas separated inside the chamber 221 out to the outside has a structure where an exhaust rate of the gas is decreased using a U-type pass or a spiral path, and therefore the separated gas does not directly get out, but is, in one embodiment of the present invention, cooled by the cooling member and then the separate gas gets out.

Also, the upper inside surface of the chamber 221 according to one embodiment of the present invention has a shape for increasing a contact area with the gaseous components, and a gas/liquid separator may be installed in the gas exhaust pipe 224 or the inside of the chamber 221 to minimize the discharge of components that may be condensed into liquid.

The radiator 227 according to one embodiment of the present invention is installed in an upper region, particularly, on an upper surface of the chamber 221 in which the gas is collected, and radiator 227 is, in one embodiment, realized in a suitable shape for increasing a heat emission area by employing materials such as metal having a thermal conductivity, the shape having a plurality of pins or wrinkles or fins.

The ventilation member 229 may be realized with an air pump or a blower fan, and is, in one embodiment, can have other applications, for example, supplying an oxidant to a cathode of a fuel cell stack.

FIG. 2C shows another embodiment of a mixing tank 220′. As shown in FIG. 2C, the mixing tank 220′ has a heat pipe 227′ installed in an upper region of a chamber 221′ in which gaseous components are collected, and a radiator 228′ for cooling heat of the heat pipe 227′ is installed on one side of the heat pipe 227′. Here, the mixing tank 220′ has a structure capable of blowing air into the heat emission unit using a ventilation member 229′.

Here, the mixing tank 220′ having a structure as shown in FIG. 2C can have a relatively high cooling efficiency and liquid condensed in a lower portion of the mixing tank 220′ is not excessively cooled because the radiator 228′ may be arranged in a position having a relatively high cooling efficiency.

As shown in FIG. 3, a fuel cell system according to one embodiment of the present invention includes a fuel cell stack 130 for generating electricity by a chemical reaction of oxygen with hydrogen; a fuel tank 110 for storing a high-density hydrogen-containing fuel (or a high density fuel or a concentrated fuel); and a mixing tank 120 for mixing a reacted emission product of the fuel cell stack 130 with the high density fuel stored in the fuel tank 110 to prepare a mixed fuel and having a structure as shown in FIG. 2A.

Also, the fuel cell system according to one embodiment of the present invention further includes a fuel pump 160 for pumping the high density fuel in the fuel tank 110 to the mixing tank 120; a feed pump 150 for pumping the mixed fuel in the mixing tank 120 to an anode electrode (anode) of a fuel cell stack; and an air pump 190 for blowing air into a cathode electrode (cathode), and the fuel cell system may further include a drive controller for controlling operations of the fuel pump 160, the feed pump 150 and the air pump 190, depending on the generation of electric power in the fuel cell system.

Also, the fuel cell system may further include a power conversion device for converting an electric energy generated in the fuel cell stack into a suitable electric current/voltage, etc. for an output level using a power conversion device and outputting the converted electric current/voltage in the form of external loads. In addition, the fuel cell system may also include a secondary battery charged with an output power of the power conversion device.

According to the embodiment, to further increase a condensation efficiency of a cathode emission product in the fuel cell stack 130, the fuel cell system may further include a precondenser for primarily condensing a cathode emission product in the fuel cell stack 130 and transmitting the condensed cathode emission product to the mixing tank 120. The precondenser may have the same (or substantially the same) structure as a conventional condenser, but the precondenser according to this embodiment is, in one embodiment, realized in a form so that only the cathode emission product can be condensed, but gas can not be separated from liquid because the gas/liquid separation is carried out in the mixing tank 120.

As shown in FIG. 4, a fuel cell system according to another embodiment of the present invention includes a fuel cell stack 130 for generating electricity by a chemical reaction of oxygen with hydrogen; a fuel tank 110 for storing a high-density hydrogen-containing fuel (or a high density fuel or a concentrated fuel); and a mixing tank 220 for mixing a reacted emission product in the fuel cell stack 130 with the high density fuel stored in the fuel tank 110 to prepare a mixed fuel and having the same (or substantially the same) structure as shown in FIG. 2B. The other parts except for the mixing tank 220 are substantially identical to those of FIG. 3.

Here, a cathode emission product discharged from a cathode electrode (cathode) of the fuel cell stack 130 according to the embodiment of the present invention flows into the mixing tank 220 in a high-temperature state where liquid is mixed with gas. The liquid components in the mixing tank 220 are accumulated downwards and the gaseous components flow upwards, and therefore the liquid is separated from the gas. The separated gas is cooled by a cooling member or pin(s) (e.g., the radiator 227 and the ventilation member 229) installed on an upper portion of the mixing tank 220, and then high molecular weight components such as methanol is condensed into liquid, and low molecular weight components such as CO₂ remains as gas, which is then discharge out of the mixing tank 220. The liquid condensed in the upper portion of the mixing tank 220 moves downwards by action of gravity and is mixed with the mixed fuel.

As shown in FIG. 5, a fuel cell system according to another embodiment of the present invention includes a fuel cell stack 130 for generating electricity by a chemical reaction of oxygen with hydrogen; a fuel tank 110 for storing a high-density hydrogen-containing fuel (or a high density fuel or a concentrated fuel); a mixing tank 220a for mixing a reacted emission product of the fuel cell stack 130 with the high density fuel stored in the fuel tank 110 to prepare a mixed fuel and having the same (or substantially the same) structure as shown in FIG. 2B; and a precondenser 380 for primarily condensing a cathode emission product in the fuel cell stack 130 and supplying the primarily condensed cathode emission product to the mixing tank 220. The other parts except for the mixing tank 220a and an additional precondenser 380 and an additional gas separator 370 are substantially identical to those of FIG. 3, and the mixing tank 220a is substantially identical to that of FIG. 4.

A gas separator 370 may be realized with porous membranes through which only gas can be passed. Loading of the mixing tank 220a may be reduced by installing the additional gas separator 370 to separate gaseous components from an anode emission product having a relatively low temperature in advance. However, the gas separator 370 may be omitted according to an embodiment, or a gas separator can also be additionally installed in the structures as shown in FIG. 3 and FIG. 4 according to certain embodiments.

The precondenser 380 may be realized with a chamber having a relatively small size; and a radiator (radiator #1) and a ventilation member 385 formed outside the chamber of the precondenser 380, as shown in FIG. 5. Also, the precondenser 380 may be realized with spiral (zigzag) ducts cooled by suitable cooling members, etc. Even if the ventilation member 385 is used as the cooling member for the precondenser 380, the ventilation member 385 may be used for other applications, for example, supplying an oxidant to a cathode of the fuel cell stack 130.

In operation, an emission product, generated in the cathode of the stack 130 configured as shown in FIG. 5, is primarily cooled in a radiator of the precondenser 380, and then supplied to the mixing tank 220a. As a result, a fluid flowing into the mixing tank 220a has a relatively small volume and a relatively low temperature, as compared to the fluid as shown in FIG. 4.

However, the configuration as shown in FIG. 5 is more complex, but a volume of the mixing tank 220a may be reduced, and a cooling efficiency of the cathode emission product may be enhanced.

Also, the total capacity of blower fan(s) as the ventilation member used in both the precondenser 380 and the mixing tank 220a may be substantially identical to the capacity of the blower fan for the mixing tank 220 as shown in FIG. 4.

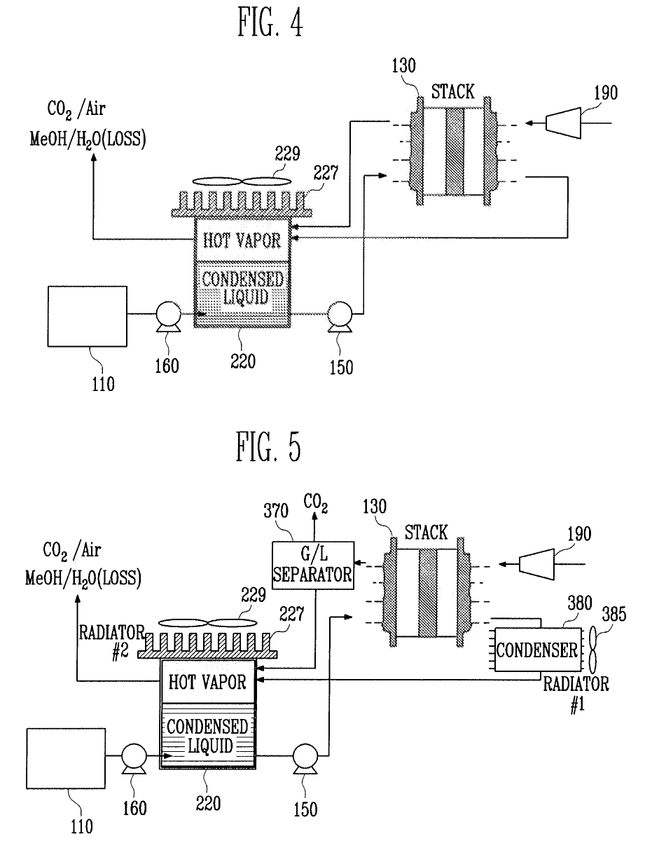

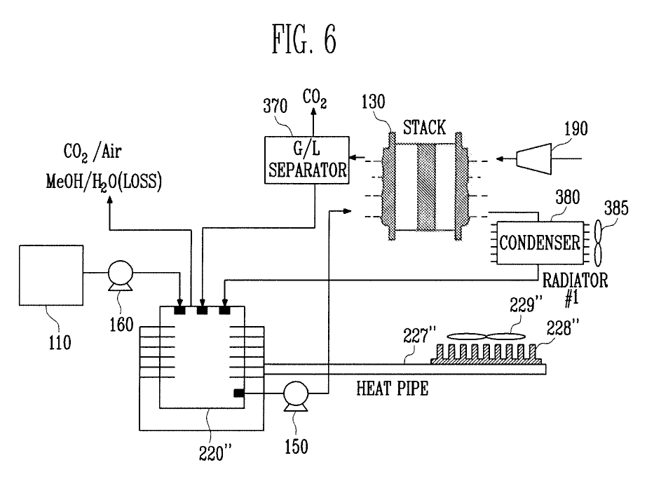

The configuration as shown in FIG. 6 may be useful to effectively lower a temperature of a mixing tank 220″ by itself, and therefore a volume of a condensing water may be further increased by cooling an outer surface of the mixing tank 220″ directly with a cooling fan or indirectly with a heat pipe to effectively lowering a temperature of the mixing tank 220″ using a cooling member (pin), etc. which is fitted into the mixing tank 220″. Also, a precondenser 380 may be omitted since a cooling efficiency of the mixing tank 220″ itself is relatively high. Therefore, the configuration of FIG. 6 is effective to further reduce a volume of the mixing tank 220″.

In view of the foregoing, a fuel cell system, using a liquid fuel, such a methanol (DMFC), with the above described configuration according to an embodiment of the present invention may effectively recover an unreacted fuel without increasing its volume.

Also, the above described configuration according to an embodiment of the present invention may further reduce a volume of the entire system because a volume of a precondenser (a heat exchanger) may be reduced or removed by installing cooling members (or pins) on the inside and/or outside of the mixing tank to maximize a cooling efficiency of the mixing tank itself.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A mixing tank comprising:
a fuel supply port for supplying a concentrated fuel;
a fluid inlet port for supplying a fluid discharged from an external fuel cell stack;
a chamber for mixing the concentrated fuel with the fluid discharged from the fuel cell stack;
a stack supply port for supplying a mixed fuel in the chamber to the fuel cell stack; and
a chamber cooling member for cooling the chamber.

2. The mixing tank according to claim 1, wherein the fluid inlet port includes:
a cathode inlet port for supplying a cathode emission product from the external fuel cell stack; and
an anode inlet port for supplying an anode emission product from the fuel cell stack.

3. The mixing tank according to claim 1, wherein the chamber cooling member is adapted to cool an upper gas collection region of the chamber.

4. The mixing tank according to claim 3, wherein the cooling member includes:
a radiator on an upper outer surface of the chamber; and
a ventilation member for blowing air into the radiator.

5. The mixing tank according to claim 3, wherein the cooling member includes:
a heat pipe for absorbing heat at an upper region of the chamber;
a radiator on the heat pipe and for cooling the heat absorbed by the heat pipe; and
a ventilation member for blowing air into the radiator.

6. The mixing tank according to claim 3, wherein an upper inside surface of the chamber is configured to have a shape for extending a contact area with gaseous components in the chamber.

7. The mixing tank according to claim 1, further comprising a gas exhaust pipe for discharging an uncondensed gas in the chamber out of the chamber.

8. The mixing tank according to claim 7, wherein the gas exhaust pipe includes a gas/liquid separator for separating liquid from gas.

9. The mixing tank according to claim 1, wherein a cooling pin is on an inside surface of the chamber.

10. A fuel cell system comprising:
a fuel cell stack for generating electricity by a chemical reaction of oxygen with hydrogen;
a fuel tank for storing a high-density hydrogen-containing fuel;
a mixing tank for mixing a reacted emission product of the fuel cell stack with the high-density hydrogen-containing fuel stored in the fuel tank and comprising a chamber; and
a chamber cooling member for cooling the chamber of the mixing tank.

11. The fuel cell system according to claim 10, wherein the chamber cooling member is adapted to cool an upper gas collection region of the chamber.

12. The fuel cell system according to claim 10, further comprising a ventilation member for supplying air to a cathode of the fuel cell stack.

13. The fuel cell system according to claim 12, wherein the ventilation member is configured to further blow a cooling air into the cooling member.

14. The fuel cell system according to claim 10, further comprising a feed pump for pumping a mixed fuel in the chamber of the mixing tank to an anode of the fuel cell stack.

15. The fuel cell system according to claim 10, further comprising a fuel pump for pumping the high-density hydrogen-containing fuel in the fuel tank to the mixing tank.

16. The fuel cell system according to claim 10, wherein the mixing tank includes:
a fuel supply port for supplying the high-density hydrogen-containing fuel;
a fluid inlet port for supplying a fluid discharged from the fuel cell stack; and
a stack supply port for supplying a mixed fuel in the chamber to the fuel cell stack.

17. The fuel cell system according to claim 16, wherein the mixing tank further includes a gas exhaust pipe for discharging gas, separated inside the chamber, out of the chamber.

18. The fuel cell system according to claim 16, wherein the fluid inlet port includes:
a cathode inlet port for supplying a cathode emission product from the fuel cell stack; and
an anode inlet port for supplying an anode emission product from the fuel cell stack.

19. The fuel cell system according to claim 10, wherein the cooling member includes:
a cooling pin on an upper outer surface of the chamber; and
a ventilation member for blowing air into the cooling pin.

20. The fuel cell system according to claim 10, wherein the cooling member includes:
a heat pipe for absorbing heat at an upper region of the chamber;
a heat emission unit for cooling the heat absorbed by the heat pipe; and
a ventilation member for blowing air into the heat emission unit.

21. The fuel cell system according to claim 10, wherein an upper inside surface of the chamber is configured to have a shape for extending a contact area with gaseous components in the chamber.

22. The fuel cell system according to claim 10, further comprising a condenser for condensing a cathode emission product in the fuel cell stack and providing the condensed cathode emission product to the mixing tank.

23. The fuel cell system according to claim 10, further comprising a gas separator for separating liquid from gas of an anode emission product in the fuel cell stack and providing the separated liquid to the mixing tank.

24. The fuel cell system according to claim 10, wherein a cooling pin is on an inside surface of the chamber.
